(19) United States
(12) Patent Application Publication
(10) Pub. No.: US 2007/0066777 A1
(43) Pub. Date: Mar. 22, 2007

(54) Methods for producing crosslinkable oligomers

(76) Inventors: Eugene Ivan Bzowej, Louisville, KY (US); Richard Hendrikus Gerrit Brinkhuis, Zwolle (NL); Mohamad Deeb Shalati, Louisville, KY (US); Petrus Johannes Maria David Elfrink, Boxmeer (NL); Gautam S. Haldankar, Louisville, KY (US)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(21) Appl. No.: 10/934,280

(22) Filed: Sep. 3, 2004

(51) Int. Cl. C08F 4/04

(52) U.S. Cl. 526/219.6; 526/346; 526/319; 526/303.1; 526/227

(57) ABSTRACT

A process for preparing crosslinkable oligomers comprising reacting at least one monomer having the structure: VHC═CHX, wherein more than 60% of such monomer or monomers has at least one crosslinkable functional moiety, and at least one monomer having the structure: WHC═CYZ at certain molar ratios and reaction conditions, in which V, X, W, and Z are predefined in the text. Curable coatings, sealants, and adhesives utilizing such crosslinkable oligomers and block, branched, star and comb-like graft crosslinkable copolymers derived from such crosslinkable oligomers are also disclosed.

### FIELD OF THE INVENTION

This invention relates to a method of producing novel crosslinkable oligomers and curable coatings, sealants, and adhesives utilizing such crosslinkable oligomers. Block, branched, star and comb-like graft crosslinkable copolymers derived from such crosslinkable oligomers are also disclosed.

### BACKGROUND OF THE INVENTION

Increasingly strict worldwide VOC regulations in the coatings and other industries and the associated reduction of the solvent content that is required to meet these VOC regulations have necessitated improvements in resin performance. Reduction of the solvent content in coatings requires improvements in solids—viscosity profiles. Typically, for low VOC systems, molecular weight and degree of polymerization is decreased in order to lower resin viscosity and solvent demand. However, the lower the molecular weight of the oligomer, the more difficult it is to incorporate sufficient crosslinking functionality by standard polymerization techniques. In fact, very low molecular weight oligomers may contain a fraction without any functionality whatsoever. The result can be poor coating performance due to insufficient crosslink density and relatively high levels of mobiles and extractable species. This loss of functionality can be offset somewhat by utilizing very high levels of functional monomers, but this solution can cause its own set of problems, such as lack of compatibility and a very high isocyanate demand. As isocyanate is one of the most expensive coating components, the latter can result in increased cost for the coating manufacturer. Additionally, conventional polymerization techniques do not offer narrow functionality distribution or narrow molecular weight distribution.

Other technology utilized to lower VOC's include the use of low molecular weight, non-oligomeric “polyols” such as 1,6-hexanediol, cyclohexane dimethanol, and trimethylolpropane. However, these suffer from very high isocyanate demand, extremely slow dry times and very high crosslink density. Also suffering from the same disadvantages, as well as being very moisture sensitive, are amine containing diluents that are blocked to attenuate reactivity, such as aldimines, ketimines and oxazolidines.

Several other techniques are also utilized to provide control in molecular structure and polymerization reactions. These include group transfer polymerization (GTP), atom transfer polymerization (ATRP), nitroxide mediated polymerization, and reversible addition-fragmentation transfer (RAFT) polymerization. Although these techniques offer impressive control in polymerization reactions, these techniques also require use of preformed reagents that are difficult to remove and are not cost effective.

Additionally, various procedures are known which attempt to ensure that crosslinkable copolymers formed with conventional radical polymerization processes contain at least one crosslinkable moiety. Usually, this is accomplished by making sure that at least one end group is associated with such a crosslinkable moiety. For example, one can utilize crosslinkable functional groups attached to initiator fragments. However, this approach can be cost prohibitive due to the combination of the high cost of the specialty initiators, and the high level of such specialty initiators that are required to achieve the targeted low molecular weight.

Crosslinkable functional groups attached to conventional chain transfer agents (e.g. mercaptoethanol) have also been used. But in addition to their higher costs, the functional mercaptans also increase the toxicity and odor of the oligomers, as well as decreasing the durability of the coatings obtained.

Functional comonomers having high chain transfer reactivity can be used, such as allylic alcohol derivatives. Guo et al, describe the “guaranteed” functionality of polyols obtained this way in “High-Solids Urethane Coatings With Improved Properites From Blends of Hard and Soft Acrylic Polyols Based on Allylic Alcohols” at pages 211-223 of the Proceedings of the Twenty-Ninth Intemational Waterborne, High-Solids & Powder Coatings Symposium, February 6-8. More particularly, this paper discusses the control of functionality in the polymer process that limits the levels of mono- and non-functional polymer chains. The polymer process also gives rise to more alternating hydroxy functional structures. Allyl alcohol monomers are used which also act as functional chain transfer agents. U.S. Pat. No. 5,571,884 and U.S. Pat. No. 5,475,073 relate to the use of allyl based hydroxyl functional monomers and low molecular weight resins, but do not specifically describe the concept of such “guaranteed” functionality. This type of approach, however, is accompanied by the need to use special kind of functional comonomers. These comonomers are less favorable from a durability point of view, compared to more broadly used methacrylates or styrenics.

Radical copolymerization of more conventional functional monomers is broadly used for making crosslinkable polymers. The use of relatively high temperature conditions for such processes is also known. However, these techniques do not clarify how the minimum functionality of functional oligomers can be increased without using any building blocks other than the comonomers and standard initiators.

U.S. Pat. No. 5,710,227 relates to the formation of a oligomer from monomers of acrylic acid and its salts and specific combinations of water, ketones, alcohols or other non-ester solvents. These oligomers have degrees of polymerization less than 50, but no process for controlling the minimum level of functionality or purity are described.

U.S. Pat. No. 6,376,626 describes the synthesis of high purity macromonomers from acrylic, styrenic, and methacrylic monomers under high temperature conditions. High purity macromonomers are obtained only when the amount of acrylic and styrenic monomers in the reaction mixture is equal or greater than half of the amount of total monomers in the reaction mixture. In Polymer Preprints, 2002, volume 43, issue 2, at page 160, Yamada also describes a copolymerization with methacrylic and acrylic monomers requiring an excess of acrylic monomers. Further, no mention of controlling the distribution of crosslinkable functionality in the macromonomer is disclosed in either document.

In WO 99/07755 and EP 1010706, a high temperature process to make macromonomers is described utilizing very high levels of styrenic and acrylic monomers, and does not describe a process for achieving enriched minimum functionality of crosslinkable side groups in the product.

U.S. Pat. No. 6,100,350 relates to the synthesis of addition polymers containing multiple branches having a polymerizable olefin group. However, a high amount of acrylate monomers is required in the reaction mixture and the use of a preformed macromonomeric chain transfer agent is required for efficient polymerization.

U.S. Patent Publication No. 2002/0193530 relates to a copolymer having pendant functionalities capable of reacting with a dicarboxylic acid.

U.S. Patent Publication No. 2004/0122195 relates to a process for producing a copolymer involving a combined macromonomer synthesis followed by a low temperature copolymerization with acrylates, wherein the mass of acrylate comonomer used is 50% or less of the total mixture of macromonomer and comonomer. Furthermore, no attention is paid to controlling the distribution of the crosslinkable functionality in the oligomers.

Thus, it is one objective of the present invention to provide a cost efficient method to produce crosslinkable oligomers with control over functionality distribution and molecular weight control.

It is a further object of the present invention to produce crosslinkable oligomers which may be formed from comonomers commonly used in practice, such as methacrylates, acrylates and styrene.

### SUMMARY OF THE INVENTION

It has surprisingly been found that when conducting a high temperature polymerization process on a reaction mixture comprising a specific ratio of certain monomers, as described further herein, crosslinkable oligomers are obtained possessing a high level of crosslinkable side groups associated with chain ends, and therefore with a relatively very low fraction of non-functional material

More specifically, a novel method for the preparation of oligomers with crosslinkable functionality is disclosed in which at least one monomer having the structure
VHC═CHX (I);
and at least one monomer having the structure
WHC═CYZ (II)
wherein V, W, X and Z are independently selected from the group consisting of halogen, R, COR, CO₂H, CO₂R, CN, CONH₂, CONHR, CONR₂, O₂CR, and OR;
R is selected from the group consisting of substituted or unsubstituted alkyl, alkenyl, phenyl, cycloalkyl, cycloalkenyl, heterocyclyl, amino, alkylamino, dilkylamino, aralkyl, silyl or aryl; Y is selected from the group consisting of substituted and unsubstituted alkyl, alkenyl, aryl, and aralkyl; and (I) and/or (II) may be cyclic wherein V and X are bonded together and/or W and Z are bonded together to form a ring that comprises at least four atoms;
   are combined to form a reaction mixture. The amount of the monomer or monomers of type (II) in the reaction mixture is between about 50 mole % and about 95 mole % based on the total number of moles of type (I) and type (II) monomers being reacted; and wherein more than 60 mole % of the monomer or monomers of type (I) have a side group containing at least one crosslinkable functional moiety.

The oligomers formed as a result of this novel process give rise to very low levels of extractable, non-crosslinkable functional material as demonstrated by mass spectrometric analysis of low molecular weight fractions. These oligomers are particularly useful for use in crosslinking formulations for adhesives, coatings and sealants.

Additionally, the oligomers formed as a result of this novel process are also particularly useful in the formation of block, branched, star, or comb-like graft crosslinkable copolymers, by using them in a second polymerization step using their unsaturated functionality as described herein.

Further objects, advantages and novel features will be apparent to those skilled in the art upon examination of the description that follows.

### DETAILED DESCRIPTION OF THE INVENTION

In the prior art, it has been suggested that under radical polymerization conditions involving only acrylates or styrene, intramolecular proton abstraction followed by fragmentation due to β-scission can lead to chains with an unsaturated end group (as shown in Scheme 1, Y═H, further referred to as macromonomers). High macromonomer purity is observed for copolymers only when very high levels of these monomers are used.
In the present invention, at least one monomer having the structure:
   VHC═CHX (I);
   and at least one monomer having the structure
   WHC═CYZ (II)
wherein V, W, X and Z are independently selected from the group consisting of halogen, R, COR, CO₂H, CO₂R, CN, CONH₂, CONHR, CONR₂, O₂CR, and OR;
R is selected from the group consisting of substituted or unsubstituted alkyl, alkenyl, phenyl, cycloalkyl, cycloalkenyl, heterocyclyl, amino, alkylamino, dilkylamino, aralkyl, silyl or aryl; Y is selected from the group consisting of substituted and unsubstituted alkyl, alkenyl, aryl, and aralkyl; and (I) and/or (II) may be cyclic wherein V and X are bonded together and/or W and Z are bonded together to form a ring that comprises at least four atoms;
   are reacted at high temperature. In the reaction of the present invention, but without wishing to be bound by theory, the hydrogen abstraction suggested by the prior art that may take place from the backbone is feasible only from methine groups originating from incorporated type (I) monomers. Therefore, the unsaturated end group will be associated with a side group (as shown by X in Scheme 1, Y≠H) of a type (I) monomer.

In light of the prior art, it was surprisingly found that when more than about 60 mole % of the type (I) monomers have crosslinkable functionality, in combination with type (II) monomers where the total amount of type (II) monomers is between about 50 mole % and 95 mole % of the total of type (I) and type (II) monomers, the resulting oligomers were found to be highly enriched with a terminal carbon-carbon double bond and enriched with a terminal, crosslinkable functional group (X).

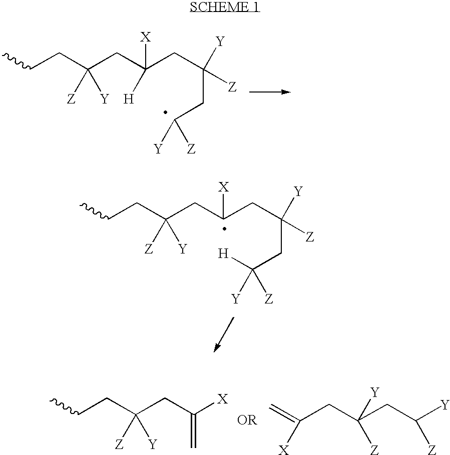

In order to insure sufficient incorporation of functional monomers and thus, low amounts of non-functional, extractable oligomer fractions, at least 60 mole % of the total amount of type (I) monomer or monomers selected for inclusion in the reaction mixture will have a side group containing at least one crosslinkable functional moiety. Preferably, at least 80 mole % of the total amount of type (I) monomer or monomers selected for inclusion will have such a side group, more preferably at least 90 mole %, and most preferably, all of the type (I) monomer or monomers selected will have the side group. To ensure a high percentage of incorporation of at least one crosslinkable functional group (X) per oligomer chain in combination with crosslinkable or non-crosslinkable type (II) functional groups (Z), both utilization of type (I) monomer or monomers which all contain at least one crosslinkable side group and very high macromonomeric purity is needed. Oligomers highly enriched with end groups containing crosslinkable side groups are formed, even when, overall, relatively low molar amounts of the type (I) monomers, in relation to the amount of type (II) monomers, are added to the reaction mixture and, therefore, not statistically expected from a simple random polymerization.

It will be apparent to one skilled in the art that the relative reactivities of the functional groups in post polymerization reactions, including crosslinking coating formulations, can be a powerful tool for manipulation of the crosslinking chemistry. This chemistry can be controlled by using mixtures of type (I) monomers with different crosslinkable side groups in the formation of the crosslinkable oligomer, which produces mixtures of crosslinkable oligomers with different crosslinkable end groups. For example, the potlife for two component crosslinking compositions may be manipulated in this way. Furthermore, it will be apparent to one skilled in the art that the relative reactivity of the functional groups to each other will be of considerable consequence and can allow one to manipulate the degree of crosslinking during the polymerization reaction and/or the post polymerization. It is also within the scope of the invention to utilize type (I) monomers that contain more than one type of crosslinkable functional group per molecule and that exhibit varying degrees of reactivity with the appropriate choice of crosslinkers.

Those skilled in the art will recognize that there are many type (I) monomers having a crosslinkable functional moiety which would be useful in the present invention, such as those type (I) monomers wherein R is substituted with one or more of the following: hydroxy, epoxy, alkoxy, acyl, acyloxy, silyl, silyloxy, silane, carboxylic acid (and salts), 1,3-dicarbonyl, isocyanato, sulfonic acid (and salts), anhydride, alkoxycarbonyl, aryloxycarbonyl, iminoether, imidoether, amidoether, lactone, lactam, amide, acetal, ketal, ketone, oxazolidinone, carbamate (acyclic and cyclic), carbonate (acyclic and cyclic), halo, dialkylamino, oxaziridine, aziridine, oxazolidine, orthoester, urea (acyclic or cyclic), oxetane or cyano. Preferably, the crosslinkable functional moiety contained in the side group is selected from the group consisting of hydroxyl, silyl, anhydride, epoxy, amine, ether, carboxylic acid, sulfonic acid, carbamate, carbonate, ketone, acetal, lactam, amide, urea, and 1,3-dicarbonyl. However, it is also within the scope of this invention to utilize a mixture of type (I) monomers with different crosslinkable functionality.

Suitable examples of monomers with hydroxyl side groups include hydroxyethyl acrylate, hydroxypropylacryate, hydroxypentyl acrylate (all isomers), hydroxyhexyl acrylate (all isomers), hydroxybutyl acrylate (all isomers), isomers of hydroxypropyl acrylate, 4-hydroxystyrene, 1,4-cyclohexanedimethanol monoacrylate, hydroethyl acrylate capped with ε-caprolactone (TONE monomers), adducts of acrylic acid with mono-epoxides such as Cardura E-10 (a glycidyl ester of neodecanoic acid available commercially from Resolution Performance Products), 1,2-epoxycyclohexane, glycidol; adducts of carbonate acrylates and amines, hydroxyethyl acrylate capped with polyethylene oxide, hydroxypropylacryate capped with polyethylene oxide, hydroxyhexyl acrylate capped with polyethylene oxide, isomers of hydroxybutyl acrylate capped with polyethylene oxide, hydroxyethyl acrylate extended with polypropylene oxide, hydroxypropylacryate extended with polypropylene oxide, hydroxyhexyl acrylate extendedcapped with polypropylene oxide, isomers of hydroxybutyl acrylate extendedwith polypropylene oxide and mixtures thereof.

Suitable examples of monomers with silyl side groups include vinyloxytrimethylsilane, trimethoxysilylpropyl acrylate, triethoxysilylpropyl acrylate, dimethoxysilylpropyl acrylate, diethoxysilylpropyl acrylate, dibutoxysilylpropyl acrylate, diisopropoxysilylpropyl acrylate.

Anhydride-functional monomers which are useful in the practice of this invention can be any aliphatic or aromatic compound having a cyclic or acylic dicarboxylic acid anhydride group and a free-radically polymerizable vinyl group in the molecule. Especially preferred in the practice of this invention is the use of anhydride-functional monomers such as acrylic acid anhydride, alkenyl succinic anhydride monomers, maleic anhydride, vinyl hexahydropthalic anhydride isomers, 3-methyl-1,2,6-tetrahydrophthalic anhydride, 2-methyl-1,3,6-tetrahydrophthalic anhydride, 2-(¾ vinyl benzyl) succinic acid, (2-succinic anhydride) acrylate, bicyclo [2.2.1] hept-5-ene-2-spiro-3′-exo-succinic anhydride. Alkenyl succinic anhydrides, including propenyl succinic anhydride and higher alkenyl anhydride, such as dodecenylsuccinic anhydride, octenylsuccinic anhydride, are routinely prepared by the reaction of maleic anhydride and olefins. Useful epoxy-functional monomers can be any aliphatic or aromatic compound having the 1,2-epoxy group and containing an ethylenically unsaturated group in the molecule that is crosslinkable towards free-radical polymerization. Examples of epoxy monomers include glycidyl acrylate, 4-hydroxybutyl acrylate glycidyl ether (4-HBAGE), vinylcyclohexene oxide, allyl glycidyl ether, N-glycidyl acrylamide, acrylate monomers with alicyclic epoxy group.

Amine functional monomers which may be utilized as type (I) monomer or monomers have amine functional side groups that can be any aliphatic or aromatic compounds having tertiary amine groups or a hindered secondary amine group and containing an ethylenically unsaturated group. Examples of amine functional monomers are selected from the group consisting of dimethylaminoethyl acrylate, diethylaminoethyl acrylate, dimethylaminoethyl acrylamide, n-t-butylaminoethyl acrylate, monomers resulting from the reaction of or t-butyl amine or dialkyl amines with glycidyl acrylate, and mixtures thereof.

Ethers monomers suitable for the practice of the present invention include acrylate, vinyl or styrenic monomers having ether or aminoplast crosslinking side groups in the molecule such as vinyl alkyl ethers and alkyloxymethyl groups. Examples of these monomers include N-alkoxymethyl derivative of acrylamide such as methylated N-methylol acrylamide and butylated N-methylol acrylamide, vinyl and acrylate monomers that contain the alkoxymethyl derivatives of ureas, amides, imides, melamines and benzoguanamines groups. Other examples include the vinyl N-alkoxymethyl derivative of succinimide, phthalimide, N-alkoxymethyl 1,2,3,6-tetrahydrophthalimide anhydride and N-alkoxymethylmaleimide.

Other monomers with crosslinkable functionality known to those skilled in the art are also suitable in the practice of this invention, such as carboxylic acid, sulfonic acid, carbamate, carbonate, ketone, acetal, lactam, amide, urea, and 1,3-dicarbonyl functional monomers. Examples of such suitable functional monomers include acrylic acid, β-carboxyethyl acrylate, 3-vinylbenzoic acid, 4-vinyl benzoic acid, vinyl acetate, vinyl benzoate, vinyl 4-tert-butyl benzoate, VEOVA (a vinyl ester of versatic acid, available commercially from Resolution Performance Products), acryloyloxyethylsuccinate, maleic acid, fumaric acid, and half-acid/esters of maleic anhydride, diacetone acrylamide, acryloyoloxy ethyl acetoacetate, 2-vinyl-1,3-dioxolane, vinyl ethylene carbonate, N-vinylcaprolactam, acrylamide, N-hydroxymethylacrylamide, 2-N-ethyleneurea-ethyloxyacrylate, and 2-N-ethyleneurea-ethyl-acrylamide.

Between 0 and about 40% of type (I) monomers utilized in the present invention may not contain a crosslinkable functional moiety. Examples of such non-functional type (I) monomers that may be useful in the present invention include methyl acrylate, ethyl acrylate, propyl acrylate, isomers of propyl acrylate, butyl acrylate, isomers of butyl acrylate, hexyl acrylate, 2-ethylbutyl acrylate, 2-ethylhexyl acrylate, isobornyl acrylate, isoamyl acrylate, benzyl acrylate, phenyl acrylate, cyclohexyl acrylate, lauryl acrylate, isodecyl acrylate, styrene, and cetyl acrylate.

One or more type (II) monomers is or are combined with the type (I) monomer or monomers within a reaction vessel. The level of type (II) monomer in the overall monomer mixture is important for the macromonomeric purity of the resulting oligomer. The amount of type (II) monomer or monomers utilized in the present invention is between about 50 mole % and 95 mole %, based on the total number of moles of both type (I) and type (II). Preferably, the amount of type (II) monomer or monomers is between about 55 mole % and 90 mole %, and more preferably, between about 60 mole % and 80 mole %. Macromonomer purity increases when greater than 50 mole % of type (II) monomers are used and is at the highest level when the amount of type (II) monomers is a range between about 60 mole % and 80 mole %.

Examples of type (II) monomers suitable for use in the present invention include, but are not limited to, methyl methacrylate, ethyl methacrylate, propyl methacrylate, isomers of propyl methacrylate, butyl methacrylate, isomers of butyl methacrylate, hexyl methacrylate, 2-ethylbutyl methcarylate, crotyl methacrylate, 2-ethylhexyl methacrylate, isobornyl methacrylate, isoamyl methacrylate, benzyl methacrylate, phenyl methacrylate, tetrahydrofurfuryl methacrylate, 3,3,5-trimethylcyclohexyl methacrylate, alphamethylstyrene, cyclohexyl methacrylate, stearyl methacrylate, lauryl methacrylate, isodecyl methacrylate. The scope of the invention is not limited to type (II) monomers without crosslinkable groups therefore, crosslinkable type (II) monomers suitable for use in the present invention include, but are not limited to, glycidyl methacrylate, 2-hydroxyethyl methacrylate, hydroxypropyl methacrylate, isomers of hydroxypropyl methacrylate, hydroxybutyl methacrylate, isomers of hydroxybutyl methacrylate, glycerolmonomethacrylate, methacrylic acid, itaconic anhydride, citraconic anhydride, dimethylaminoethyl methacrylate , diethylaminoethyl methacrylate, dimethylaminopropyl methacrylamide, 2-tert-butyl aminoethyl methacrylate, triethyleneglycol methacrylate, methacrylamide, N,N-dimethyl methacrylamide, N-tert-butyl methacrylamide, N-methylol methacrylamide, N-ethylol methacrylamide, alphamethylvinyl benzoic acid (all isomers), diethylamino alphamethylstyrene, 2-isocyanatoethyl methacrylate, isomers of diethylamino alphamethylstyrene, trimethoxysilylpropyl methacrylate, triethoxysilylpropyl methacrylate, methacrylic acid, tributoxysilyipropyl methacrylate, dimethoxymethylsilylpropyl methacrylate, diisopropoxymethylsilylpropyl methacrylate, dimethoxysilylpropyl methacrylate, diethoxysilylpropyl methacrylate, d dibutoxysilylpropyl methacrylate, diisopropoxysilylpropyl methacrylate, isobutylene, and mixtures thereof.

Optionally, the type (I) and type (II) monomers are reacted in the presence of at least one free radical initiator, which may be added to the reactor vessel as part of the mixture of type (I) and type (II) monomers or as a separate feed. When added as a separate feed, the initiator may be added at the same rate as the mixture of type (I) and (II) monomers to synchronize the completion of the feeds, or may be added slower or faster than the rate of addition of the monomer mixture. Any conventional free radical initiator, chosen by one skilled in the art to have the appropriate half-life at the temperature of polymerization, may be utilized in the present invention. For example, suitable initiators include ether or acyl hydroperoxides, di-ether or di-acyl peroxides, peroxydicarbonates, mixed ether acyl peroxides, mixed ether peroxy carbonates, and mixed acyl peroxy carbonates in which substitution on the peroxide is by any alkyl and/or aryl group. Azo initiators can also be disubstituted with either alkyl or aryl groups. Examples of suitable alkyl groups include, but are not limited to, methyl, ethyl, butyl, isobutyl, tert-butyl, tert-amyl, diisopropylbenzyl, cetyl, 2,2,4-trimethylpentyl, isopropyl, 2-ethylhexyl, neodecyl, valeryl. Examples of suitable aryl groups include, but are not limited to, benzyl, phenyl, 1,1-diphenylmethyl, 1-phenylethyl, phthalyl, cumyl, and all isomers of diisopropylbenzyl. Preferred initiators include peroxides or azo-based initiators, such as tert-amyl hydroperoxide, tert-butyl hydroperoxide, cumyl hydroperoxide, 2,4,4-trimethylpentyl-2-hydroperoxide, di-tert-butyl peroxide, tert-butyl cumyl peroxide, dicumyl peroxide, 2,2′-azobis(isobutyronitrile) and 2,2′-azobis(2-methylbutyronitrile).

Those skilled in the art will recognize that when an initiator is utilized in a reaction it is important to choose an amount that is suitable for the particular reaction conditions and monomer content to ensure a balance between monomer conversion and, as disclosed in the present invention, macromonomer purity. In the present invention, the initiator is added in an amount between about 0.1 mole % and about 5 mole %, based on the number of moles of type (I) and (II) monomers being reacted. Preferably, between about 0.1 mole % and 2 mole % is added, and more preferably, between about 0.1 mole % and about 1 mole % of initiator is added. At initiator levels greater than 5 mole %, the purity of the macromonomer decreases significantly and, therefore, the control of crosslinkable functionality in the oligomer correspondingly decreases.

In one preferred embodiment of the present invention, a chase procedure is performed wherein an additional amount of at least one free radical initiator may optionally be added upon the substantial completion of the reaction process in order to further polymerize any residual type (I) and/or (II) monomers remaining in the reaction solution. Preferably, the chase procedure is conducted at temperatures below about 170° C. Any free radical initiator which may be utilized during the initial reaction process may also be utilized in the chase procedure.

Within the reactor vessel, a pressure is sustained which is sufficient to maintain the monomers and initiator in a substantially liquid phase during the reaction. Further, a temperature between about 170° C. and about 260°, preferably between about 175° C. and about 240° C., more preferably between about 185° C. and about 220° C., and even more preferably between about 190° C. and about 210° C. is maintained throughout the reaction. Those skilled in the art will recognize that, within these limitations, the exact pressure and temperature will vary with the monomers and optionally, the initiators being used and the amounts of such monomers and optional initiators being reacted.

A solvent or diluent may also optionally be added to the reactants, preferably prior to the addition of the type (I) and (II) monomers and the optional free radical initiator. However, the solvent/diluent, or a portion thereof, may also be added during the addition of the monomers and the optional initiator. Although the solvent or diluent may be added at any level, it is preferable to carry out the reaction at a solids content of greater than about 50 weight %.

Suitable solvents and diluents include those that react under the conditions of the polymerization independent of the radical reactions or are inert or substantially inert under the conditions of the polymerization but are reactive under post polymerization conditions including coating crosslinking reactions (e.g., the solvent/diluent may be a crosslinkable low molecular weight component which does not participate in the radical reactions, or a higher molecular weight preformed oligomer/resin). It will be apparent to those skilled in the art that under the latter instance, the diluent functions both as a solvent in the main polymerization reaction and as a reactant in the post polymerization reaction. Such solvents or diluents may also react with the crosslinkable side group functionality in type (I) and/or type (II) monomers in situ, either retaining or increasing the number of side groups available. It will also be apparent to those skilled in the art that it is possible to change the type of crosslinkable functional group in situ by an appropriate choice of functional monomer, diluent and reaction conditions. The solvent or diluent may contain one or more functional groups that are reactive as described above. If there is a plurality of functional groups in the solvent or diluent, the functional groups may be the same or may be a mixture of more than one type of functional group with varying degrees of reactivity towards the crosslinkable side groups and/or other components of the crosslinking formulation.

Examples of suitable solvents and diluents include, but are not limited to, esters, ketones (e.g. methyl amyl ketone, methylisobutyl ketone, diethylketone), carbonates (e.g. ethylene carbonate, propylene carbonate, glycerin carbonate), carbamates (methyl carbamate, hydroxyethyl carbamate and hydroxypropyl carbamate), aromatic and (cyclo)aliphatic hydrocarbons (e.g. perhydronaphtalene, tetrahydronaphtalene, xylenes, o-dichlorobenzene), alcohols, glycol ethers, glycol ether esters, oxazolidines, acetals, orthoesters and mixtures thereof. Preferably, the solvent is an ester solvent. Suitable examples of ester solvents include methyl acetate, ethyl acetate, n-buty acetate, n-butyl proprionate, isobutyl acetate, n-pentyl propionate, n-propyl acetate, isopropyl acetate, amyl acetate,isobutyl isobutyrate and ethyl 3-ethoxypropionate. In one preferred embodiment, the diluent is an oligomeric polyester with an OH value of at least 100 mg KOH/g, and a number average molecular weight of less than 2000.

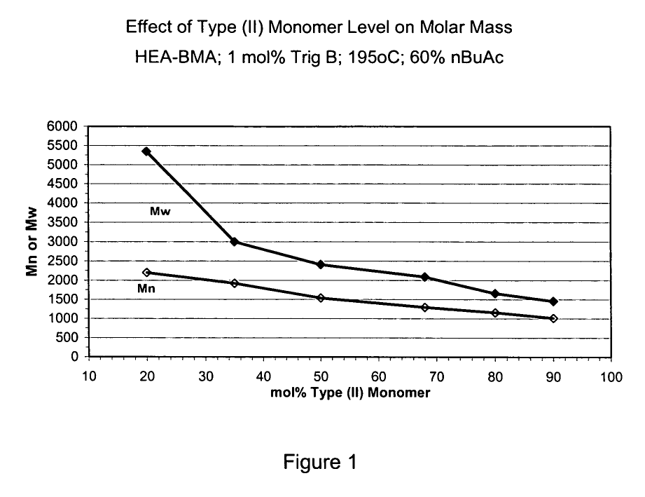

It has been found that the crosslinkable oligomers produced by the process of the present invention preferably have a number average degree of polymerization between about 3 and about 24. More preferably, the number average degree of polymerization is between about 3 and about 15 and most preferably, the number average degree of polymerization is between about 3 and 10. As the graph in FIG. 1 indicates, the disclosed process provides a very powerful tool for controlling molecular weight and molecular weight distribution within the range of type (II) monomer content being practiced.

The novel, crosslinkable oligomers formed through the present invention have been found to be particularly useful for lubricants, adhesives, sealants and coatings due to the low levels of non-functional, extractable oligomer fractions provided by the process. The most preferred crosslinkable oligomers for use in such lubricants, adhesives, sealants and coatings are the crosslinkable oligomers formed when 100 mole % of the type (I) monomer or monomers selected have a side group containing at least one crosslinkable functional moiety as described above.

The crosslinkable oligomers of the present invention have also been found to be useful in further copolymerizations. Preferably, block, branched, star, and comb-like graft crosslinkable copolymers may be formed through a further polymerization wherein the reactive oligomer is further reacted with a free radical initiator and an additional monomer or monomers. For example, the crosslinkable oligomers may be block copolymerized with type (II) monomers, optionally with crosslinkable functional units to enrich the concentration of crosslinkable functionality, especially in low molecular weight oligomer fractions. When crosslinkable functional type (II) monomers are used in this step, this incorporates a functionality gradient with an increase in, for example, hydroxy equivalent weight (HEW) as molecular weight of the oligomers increases. Such a functionality gradient leads to better distribution of crosslinkable functionality without the requirement of very high levels of crosslinkable functional monomers (both type (I) and type (II)). Further, in the most preferred embodiment (e.g. when all type (I) monomers have crosslinkable functionality), the oligomer fractions with type (I) monomer penultimate units, that may block-extend less efficiently with type (II) monomers, already contain at least two crosslinkable functional type (I) monomers and have more favorable crosslinkable functionality distribution. Overall, therefore, crosslinkable oligomers are formed that are enriched with at least two crosslinkable side groups per oligomer chain. The number of oligomer chains that contain no crosslinkable functionality, or only one crosslinkable functionality, is reduced. This, in turn, can lead to better network formation in crosslinking formulations. Alternatively, if the type (II) monomers contain non-crosslinkable functionality, it is possible to obtain block type crosslinkable copolymers with segmented regions of crosslinkable functionality, separated by a mid-segment with little or no crosslinkable functionality.

For example, a crosslinkable copolymer may be formed from a crosslinkable oligomer made in accordance with the present invention to which a mixture of type (I) and type (II) monomers is added, at least 50 mole % of the mixture being type (II) monomers, and in which the average OH value of the mixture of type (I) and (II) monomers is less than half of the average OH value of the crosslinkable oligomer and the mass of the mixture is greater than half of the mass of the crosslinkable oligomer.

A crosslinkable copolymer may also be formed from a crosslinkable oligomer made in accordance with the present invention to which a mixture of type (I) and type (II) monomers is added, at least 50 mole % of the mixture being type (II) monomers, but in which the average OH value of the mixture of type (I) and (II) monomers is more than twice the average OH value of the crosslinkable oligomer and the mass of the mixture is less than half of the mass of the crosslinkable oligomer.

The crosslinkable oligomers can also be copolymerized with type (I) monomers to form branched crosslinkable copolymers or copolymerized with a monomer of the type:
(CH₂═CH)ₙ—U—(CY′═CHW′)ₘ (III)
where n is greater than or equal to 0; m is greater than or equal to 0; n+m is greater than or equal to 2; Y′ and W′ is defined as for Y and W, respectively, in the type (II) monomers; and U is a point of attachment for more than one C═C units;
   to form highly branched or star-type crosslinkable copolymers.

Suitable examples of type (III) monomers useful in the present invention include divinylbenzene, trimethylolpropane trimethacrylate, trimethylolpropane triacrylate, glycerol-1,3-dimethacrylate, polyethylene glycol 200-dimethacrylate, allyl methacrylate, 1,4-butanediol dimethacrylate, 1,4-butanediol diacrylate 1,3-butanediol dimethacrylate, ethyleneglycol dimethacrylate, ethyleneglycol diacrylate, triethylene glycol dimethacrylate, triethylene glycol diacrylate 1,6-hexanediol dimethacrylate, diurethane dimethacrylate, 2,2-bis[4-(2-hydroxy-3-methacryloyloxy-propoxy)phenyl]-propane, and 1,12-dodecanediol dimethacrylate.

It is also within the scope of this invention to copolymerize the crosslinkable oligomers with any mixture of type (I), type (II) or type (III) monomers. In all cases, the number of crosslinkable functional groups in any copolymer chain in the final product will be at least equal to the sum of the number of functional groups in every macromonomer oligomer incorporated in that copolymer chain such that the average minimum functionality of the copolymer product will increase proportionally with the average minimum functionality of the macromonomer oligomers and the average number of oligomers incorporated in the copolymer.

Such copolymerization may be performed immediately following the formation of the crosslinkable oligomers and in the same reaction vessel as the crosslinkable oligomers. Alternatively, the copolymerization of the crosslinkable oligomers may be performed in a separate reaction vessel. The copolymerizations may be carried out under batch, semi-batch, continuous or loop reactor conditions.

Certain intermediate processes may optionally be performed on the crosslinkable oligomers prior to any additional copolymerization. In one embodiment, any residual monomer that was not consumed during the polymerization may be removed in order to isolate the crosslinkable oligomers. Additionally, if solvent/diluent was added during the formation of the crosslinkable oligomers, then prior to copolymerization, such solvent/diluent may also be removed with any residual monomers in order to isolate the crosslinkable oligomers prior to beginning the copolymerization. This procedure may be performed in the same reaction vessel as the crosslinkable oligomers were prepared, or in a separate reaction vessel.

In one preferred embodiment, a chase procedure, as described above, may be performed as an intermediate process to consume any unreacted type (I) and type (II) monomers. In this case, any solvent /diluent used may be removed in order to isolate the crosslinkable oligomers prior to beginning the copolymerization. This method can improve the cost efficiency of the reaction if significant residual monomers remain. It can also lead to more well-defined copolymers by avoiding mixing of any residual monomers left over from the formation of the oligomers and the additional monomers selected for the copolymerization that would occur in the early stages of the copolymerization.

The crosslinkable oligomers of the present invention may also be used in a subsequent step wherein the crosslinkable side group functionality in the type (I) and/or type (II) monomers that have been incorporated into the crosslinkable oligomer are modified by reacting with an appropriate reagent that either retains or increases the number of crosslinkable side groups available. The new crosslinkable side group or groups may be the same as the premodified crosslinkable side group, may be a different crosslinakble side group, or may even be a mixture of two or more crosslinkable side groups. Suitable modifying reagents include any that will chemically react with the crosslinkable side groups previously described provided they do not lower the number of crosslinkable side groups available. Furthermore, such modifying reagents may be monofunctional or polyfunctional, or a mixture of modifying agents containing various degrees of functionalization. In the case of polyfunctional reagents, the functional groups may all be the same type or a combination of more than one type.

Suitable reagents have one or more of following functional groups: epoxy, silyl, isocyanato, amino, anhydride, hydroxy, iminoether, imidoether, amidoether, carbamate, cyano, lactone, lactam, carbamate (acyclic and cyclic), carbonate (acyclic and cyclic), aziridine, anhydride, amine, carboxylic acid. Suitable specific reagents include, but are nor limited to: ε-caprolactone, methyl carbamate, Cardura E-10 (glycidyl ester of neodecanoic acid), ethylene carbonate, propylene carbonate, methyl carbamate, hydroxypropyl carbamate, ammonia, isophorone diisocyanate, succinic anhydride, hexahydrophthalic anhydride, methyl hexahydrophthalic anhydride, dimethylolpropionic acid, resorcinol diglycidyl ether. It will be apparent to those skilled in the art that the choice of modifying reagent and reaction conditions will be dependant on the type of existing crosslinkable functionality in the oligomer and by the type of crosslinkable functionality desired in the resulting oligomer. For example, an oligomer with carboxylic acid crosslinkable functionality may be modified with an epoxy functional reagent producing a hydroxyl functional oligomer.

The above reaction may be carried out on the crosslinkable oligomer in the same reaction vessel as the preparation of the crosslinkable oilgomer directly after substantial formation of the crosslinkable oligomer. It may also be carried out after an optional chase procedure or the other intermediate procedures, as described above. The product of the above reaction may also be copolymerized with any mixture of type (I), type (II) or type (III) monomers as described for the crosslinkable oligomers above, since the product retains the unsaturated end group of the initial crosslinkable oligomer.

The following examples are illustrative and do not limit the scope of the invention. All of the following examples were reacted in a sealed reactor vessel pressurized as indicated. A mixture of the monomers and polymerization initiator was fed into the reactor at a constant rate. The temperature of the reactor was equilibrated to the temperature(s) indicated in each example.

As otherwise indicated, type (I) and type (II) monomer quantities are expressed in mole % of total monomer. Polymerization initiator quantities are expressed as mole % of the total monomer quantity in moles. Concentrations of monomers in solvent are expressed as weight %, unless indicated otherwise. Molecular weights were obtained using GPC (gel permeation chromatography) with a combination of PL100 and PL1000 columns from Polymer Labs using polystyrene standards.

Macromonomer purity was determined by comparing observed Mn (GPC) with Mn calculated using NMR spectroscopy and reflects the % of oligomers with unsaturated end groups. Crosslinkable functionality incorporation in low molecular weight oligomers was determined using ESI-MS Spectroscopy. DP (degree of polymerization) was calculated using Mn obtained from GPC. All reactions were carried out either in a 6.5 liter stainless steel pressure reactor equipped with heating and cooling regulators, a mechanical stirrer, pressure and temperature gauges, and pressurized metering pumps, unless indicated otherwise, or in a glass/stainless steel 250 ml reactor with similar control accessories.

### EXAMPLE 1

In Example 1, HEA-BMA crosslinkable oligomers were prepared to illustrate the effect of type II monomer level on macromonomer purity and molecular weight distribution. Example 1A is a comparative example while experiments 1 B and 1C are examples of the present invention. The experiments were carried out at 4 moles/liter total monomer concentration and 1 mole % initiator level. The results are shown in Table 1.

### COMPARATIVE EXAMPLE 1A

A 6.5-liter stainless steel pressure reactor was charged with 1170 grams of n-butyl acetate, pressurized to 75 psi and heated to 195° C. A mixture of 975.4 grams 2-hydroxyethyl acrylate, 298.6 grams n-butyl methacrylate and 15.35 grams di-t-butyl peroxide was fed into the reactor over a period of 1.5 hours. After an additional 45 minutes, the mixture was cooled, the pressure released and 1050 grams of volatiles were removed by distillation. A resin sample was further concentrated in vacuo to remove all volatiles and analyzed.

### EXAMPLE 1B & 1C

Using the amounts of monomers and solvent listed in Table 1 and the same procedure as Example 1A, Examples 1B & 1C were carried out. The additional heating periods, post the monomers addition, were 85 and 60 minutes and the amounts of volatiles removed were 811 and 770 grams, for 1 B and 1 C, respectively.

TABLE 1

| | | Monomers | Solvent | | | | | | |
|---|---|---|---|---|---|---|---|---|---|
| | HEA:BMA | HEA:BMA | BuAC | | | | | Macromer | Wt % |
| Example | Mole ratio | Weight (g) | Weight (g) | DP | Mn | Mw | Pd | Purity | Solids |
| 1A | 80:20 | 975:299 | 1170 | 18 | 2194 | 5342 | 2.43 | 53 | 52 |
| 1B | 32:68 | 399:1038 | 995 | 10 | 1291 | 2083 | 1.61 | >95 | 59 |
| 1C | 20:80 | 247:1209 | 935 | 9 | 1255 | 2258 | 1.8 | >95 | 61 |

Mass Spectroscopic data for Example 1C indicated the number and type of monomer units in each oligomer. The data indicated that all significant oligomers in the low molecular weight fractions contain at least one HEA unit.

| | m/z | | | | | | | | | |
|---|---|---|---|---|---|---|---|---|---|---|
| | 423.3 | 539.4 | 565.4 | 681.4 | 707.5 | 823.6 | 849.6 | 965.7 | 991.8 | 1107.8 |
| # HEA units | 1 | 2 | 1 | 2 | 1 | 2 | 1 | 2 | 1 | 2 |
| # BMA units | 2 | 2 | 3 | 3 | 4 | 4 | 5 | 5 | 6 | 6 |

The above results clearly, but unexpectedly, demonstrate that when the ratio of type II/type I monomers is in the range of the present invention, the macromonomer purity of the HEA-BMA crosslinkable oligomers in examples 1B and 1C is very high when compared with the macromer purity of the HEA-BMA oligomer in comparative example 1A. Additionally, the use of HEA (hydroxyethyl acrylate) as the only type I monomer yields a very high concentration of low molecular weight oligomers that contain at least one crosslinkable functional group, even in example 1C where HEA levels are low.

### EXAMPLE 2

In Example 2, HEA-BMA crosslinkable oligomers were prepared to illustrate the effect of type 11 monomer level on macromonomer purity and molecular weight distribution. The level of initiator, 0.1 mole %, was in the lower level of the preferred range, instead of 1.0 mole % as in example 1. Example 2A is a comparative example while experiments 2B and 2C are examples of the present invention. The experiments were carried out at 4 moles/liter total monomer concentration and 0.1 mole% initiator level. The results are shown in Table 2.

### COMPARATIVE EXAMPLE 2A, EXAMPLE 2B AND EXAMPLE 2C

Using the amounts of monomers and solvent listed in Table 2 and the procedures of Example 1A, Examples 2A, 2B and 2C are made. The additional heating periods, post the monomers addition, were 30, 60 and 55 minutes and the amounts of volatiles removed were 1024, 800, and 806 grams, for 2A, 2B and 2C, respectively.

TABLE 2

| | | Monomers | Solvent | | | | | |
|---|---|---|---|---|---|---|---|---|
| | HEA:BMA | HEA:BMA | nBuAC | | | | | Macromer |
| Example | Mole ratio | Weight (g) | Weight (g) | DP | Mn | Mw | Pd | Purity |
| 2A | 80:20 | 975:299 | 1170 | 24 | 2929 | 10728 | 3.66 | 68 |
| 2B | 32:68 | 399:1038 | 995 | 18 | 2225 | 5256 | 2.36 | 88 |
| 2C | 20:80 | 247:1209 | 935 | 14 | 1936 | 5373 | 2.78 | >95 |

Again the above results clearly, but unexpectedly, demonstrate that when the ratio of Type II/Type I monomers is in the range of the present invention, the macromonomer purity of the HEA-BMA crosslinkable oligomers in examples 2B and 2C is high when compared with the comparative example 2A.

### EXAMPLE 3

In Example 3, HEA-HEMA-MMA-BMA crosslinkable oligomers were prepared to illustrate the effect of initiator level on macromonomer purity and molecular weight distribution. Type II monomer level was constant at 90 mole %. The results are shown in Table 3.

### EXAMPLE 3A

A 6.5-liter stainless steel reactor was charged with 1800 grams of n-butyl acetate, pressurized to 75 psi and heated to 195° C. A mixture of 158.4 grams 2-hydroxyethyl acrylate, 325.8 grams of 2-hydroxyethyl methacrylate, 1144.8 grams n-butyl methacrylate, 171.0 grams methyl methacrylate and 23.9 grams di-t-butyl peroxide was fed into the reactor over a period of 3.3 hours. At the conclusion of the monomer feed, the reactor was cooled and a sample of resin was removed for analytical analysis.

### EXAMPLE 3B AND EXAMPLE 3C

Examples 3B and 3C were carried out according to the procedure of Example 3A except for the amounts of initiator which are listed in Table 3.

TABLE 3

| | mole % | | | | | Macromer |
|---|---|---|---|---|---|---|
| Example | di-t-butyl peroxide | DP | Mn | Mw | Pd | Purity |
| 3A | 1.2 | 6 | 835 | 1100 | 1.32 | 94 |
| 3B | 3.0 | 6 | 828 | 1042 | 1.25 | 83 |
| 3C | 5.0 | 6 | 768 | 954 | 1.23 | 56 |

The monomer composition for 3A, 3B, and 3C is identical and equal to: HEA/HEMA/BMA/MMA: 10/18/59/13 mole %.

The results of Table 3 demonstrate that macromonomer purity decreases as the level of initiator is increased and that molecular weight is low at type (II) monomer content of 90 mole %.

### EXAMPLE 4

In Example 4, HEA-BMA crosslinkable oligomers were prepared to illustrate the effect of initiator level within the preferred range of type (II) monomer levels. Experiments were carried out at 68 mole % of the type (II) monomer, BMA, and 32 mole % of the type (I) monomer, HEA. The results are shown in Table 4.

### EXAMPLE 4A

A 6.5-liter stainless steel reactor was charged with 995 grams of n-butyl acetate, pressurized to 75 psi and heated to 195° C. A mixture of 398.9 grams 2-hydroxyethyl acrylate, 1038.1 grams n-butyl methacrylate and 1.57 grams di-t-butyl peroxide was fed into the reactor over a period of 1.5 hours. After an additional 60 minutes, the mixture was cooled, the pressure was released and 800 grams of volatiles were removed by distillation. A resin sample was further concentrated in vacuo to remove all volatiles and analyzed.

### EXAMPLE 4B AND 4C

Example 4B and 4C were carried out identically to example 4A, except that 8.63 grams di-t-butyl peroxide was used in 4B and 15.7 grams di-t-butyl peroxide was used in 4C. In example 4B, 886 grams of volatiles were removed and in example 4C 811 grams of volatiles were removed.

TABLE 4

| | mole | | | | | Macromer |
|---|---|---|---|---|---|---|
| Example | % di-t-butyl peroxide | DP | Mn | Mw | Pd | Purity |
| 4A | 0.1 | 17 | 2225 | 5262 | 2.36 | 88 |
| 4B | 0.6 | 11 | 1499 | 2644 | 1.76 | 94 |
| 4C | 1.0 | 10 | 1291 | 2083 | 1.61 | >95 |

The above results clearly demonstrate that macromer purity is high in the preferred range of initiator level and type (II) monomer content.

### EXAMPLE 5

In Example 5, HEA-HEMA-MMA-BMA crosslinkable oligomers were prepared to illustrate the effect of temperature on the macromer purity and molecular weight distribution. Type (II) monomer content was 90 mole % and initiator level was 1.2 mole %. The results are shown in Table 5.

### EXAMPLE 5A

A 6.5-liter stainless steel reactor was charged with 1800 grams of n-butyl acetate, pressurized to 55 psi and heated to 175° C. A mixture of 159.1 grams 2-hydroxyethyl acrylate, 326.0 grams of 2-hydroxyethyl methacrylate, 1144.7 grams n-butyl methacrylate, 171.1 grams methyl methacrylate and 23.9 grams di-t-butyl peroxide was fed into the reactor over a period of 3.3 hours. At the conclusion of the monomer feed, the reactor was cooled and a sample of resin removed for analytical analysis.

### EXAMPLE 5B

Example 5B was carried out identical to 5A except that the polymerization was carried out at 195° C. and 75 psi.

TABLE 5

| Example | Temp (° C.) | DP | Mn | Mw | Pd | Macromer Purity |
|---|---|---|---|---|---|---|
| 5A | 175 | 13 | 1657 | 2878 | 1.74 | 73 |
| 5B | 195 | 7 | 862 | 1372 | 1.59 | 94 |

The above results clearly demonstrate that macromer purity decreases and molecular weight increases at lower temperature and 90 mole % type (II) monomer content.

### EXAMPLE 6

In example 6, HEA-BMA crosslinkable oligomers were prepared to illustrate the effect of reaction solids on macromer purity and molecular weight distribution in the preferred range of type (II) monomer content. Experiments were carried out at 68 mole % BMA, 32 mole % HEA and 1.0 mole % di-t-butyl peroxide initiator. The solids content was 60 weight % and 75 weigh %, using n-butyl acetate as solvent. The results are shown in Table 6.

### EXAMPLE 6A

A 6.5-liter stainless steel reactor was charged with 995 grams of n-butyl acetate, pressurized to 75 psi and heated to 195° C. A mixture of 398.9 grams 2-hydroxyethyl acrylate, 1038.1 grams n-butyl methacrylate and 15.7 grams di-t-butyl peroxide was fed into the reactor over a period of 1.5 hours. After an additional 60 minutes, the mixture was cooled, the pressure was released and 811 grams of volatiles were removed by distillation. Aresin sample was further concentrated in vacuo to remove all volatiles and analyzed.

### EXAMPLE 6B

Example 6B was carried out identical to 6A, except that the amount of n-butyl acetate was 1000 grams, the amount of 2-hydroxyethyl acetate was 832.8 grams, the amount of n-butyl methacrylate was 2167.3 grams and the amount of di-t-butyl peroxide was 32.8 grams.

TABLE 6

| Sample | % Solids | DP | Mn | Mw | Pd | Macromer Purity |
|---|---|---|---|---|---|---|
| 15 | 60 | 10 | 1291 | 2083 | 1.61 | 94 |
| 16 | 75 | 11 | 1509 | 2512 | 1.66 | >95 |

The above results clearly indicate that solids content has a minimal effect on macromer purity in preferred ranges of type (II) monomer and initiator content.

### EXAMPLE 7

In Example 7, HEA-HEMA-MMA-BMA crosslinkable oligomers were prepared to illustrate the effect of reaction solids on macromer purity and molecular weight distribution. Type (II) monomer content was 90 mole % and initiator level was 5.0 mole %. The solids content was 60 weight %, 70 weight % and 80 weight %, using n-butyl propionate as solvent. The results are shown in Table 7.

### EXAMPLE 7A

A 6.5-liter stainless steel reactor was charged with 2000 grams of n-butyl propionate, pressurized to 60 psi and heated to 200° C. A mixture of 176.0 grams 2-hydroxyethyl acrylate, 362.0 grams of 2-hydroxyethyl methacrylate, 1272.0 grams n-butyl methacrylate, 190.0 grams methyl methacrylate and 110.7 grams di-t-butyl peroxide was fed into the reactor over a period of 4 hours. At the conclusion of the monomer feed, the reactor was cooled and a sample of resin was removed for analytical analysis.

### EXAMPLE 7B

Example 7B was carried out identical to 7A with the following amounts of material: 1170 grams of n-butyl propionate, 240.2 grams 2-hydroxyethyl acrylate, 504.0 grams of 2-hydroxyethyl methacrylate, 1736.3 grams n-butyl methacrylate, 259.4 grams methyl methacrylate and 151.1 grams di-t-butyl peroxide.

### EXAMPLE 7C

Example 7C was carried out identical to 7A with the following amounts of material: 682.5 grams of n-butyl propionate, 240.2 grams 2-hydroxyethyl acrylate, 494.1 grams of 2-hydroxyethyl methacrylate, 1736.3 grams n-butyl methacrylate, 259.4 grams methyl methacrylate and 151.1 grams di-t-butyl peroxide.

TABLE 7

| | | | | | | Macromer |
|---|---|---|---|---|---|---|
| Sample | % Solids | DP | Mn | Mw | Pd | Purity |
| 17 | 50 | 5 | 710 | 902 | 1.27 | 57 |
| 18 | 70 | 6 | 804 | 1073 | 1.33 | 63 |
| 19 | 80 | 7 | 874 | 1756 | 2.01 | 64 |

The above data clearly indicate that macromer purity is relatively insensitive to the total weight content of monomers and that low molecular weight oligomers can be formed under high solids conditions. The overall lower macromonomer purity observed in these examples when compared with previous examples is attributable to the use of higher levels of free radical initiator.

### EXAMPLE 8

Example 8 illustrates the preparation of a crosslinkable oligomer using an epoxy functional type (I) monomer. A 6.5-liter stainless steel reactor was charged with 640.0 grams of n-butyl propionate, pressurized to 66 psi and heated to 200° C. A mixture of 393.2 grams of 4-HBAGE (4-hydroxybutyl acrylate, glycidyl ester), 567.8 grams of n-butyl methacrylate and 8.74 grams di-t-butyl peroxide was fed into the reactor over a period of 2 hours. After an additional 40 minutes, the reactor was cooled, pressure released and a sample of resin was removed for analytical analysis. The final resin was characterized by an Mn 1082, Mw 1625, Mz 2436 and an epoxy equivalent weight of 430 mg KOH/g solids.

### EXAMPLE 9

Example 9 describe the preparation of crosslinkable oligomers made in the presence of a diluent that reacts with the crosslinkable functional group of a type (I) monomer during the polymerization step.

### EXAMPLE 9A

A 250 mL stainless steel pressure reactor was filled with 100 grams of ε-caprolactone, pressurized to 43 psi and heated to 200° C. A mixture of 29.5 g HEA, 33.0 g HEMA, 36.1 g BMA and 1.48 g of Trigonox B was fed over a period of six hours followed by cooling to ambient temperature. The solids content of the material was 94% at this stage. The reaction mixture was further concentrated by stripping in vacuo. The resulting materials had an Mn of 1670, Mw of 3850 and a hydroxy equivalent weight of 438. The macromeric purity was calculated to be 80%.

### EXAMPLE 9B

A 6.5-liter stainless steel reactor was charged with 1402.4 grams of Cardura E-10 (glycidyl ester of neodecanoic acid), pressurized to 62 psi and heated to 195° C. A mixture of 445.1 grams of acrylic acid, 656.3 grams of methyl methacrylate, 525.7 grams of n-butyl methacrylate and 36.3 grams di-t-butyl peroxide was fed into the reactor over a period of 2.5 hours. After an additional 40 minutes, the reactor was cooled and a sample of resin was removed for analytical analysis. Conversion was 95.7 % calculated from non-volatile solids analysis. The final polyol was characterized by an Mn 1391, Mw 2592, Mz 4176 and an acid value of 0.8 mg KOH/g solids.

Examples 9A and 9B illustrate the utility of the present invention for carrying out reactions in the presence of reactive diluents without the use of additional solvent. Example 9B further illustrates the in situ transformation from carboxylic acid to hydroxyl crosslinkable functionality.

### EXAMPLE 10

Example 10 was a comparative analysis of a crosslinkable oligomer prepared in accordance with the present invention and a comparative oligomer prepared from the type (I) monomer, n-butyl acrylate, which was lacking a crosslinkable functional group. Measured hydroxy equivalent weight (HEW) values, molecular weight distributions and Tg's were kept constant for the two copolymers.

### EXAMPLE 10A

A 250 mL stainless steel reactor was filled with 100 grams of o-dichlorobenzene and heated to 200° C. under a pressure of 52 psi. Subsequently, a mixture of 27.91 grams of HEA, 70.63 grams of n-butylmethacrylate and 1.46 grams of di-t-butyl peroxide was fed to the reactor over a period of 6 hours. After cooling, the reaction product was stripped in vacuo to remove the volatiles. The product was characterized by an Mn of 933 and a Mw of 1271, a measured Tg of −50° C. and a hydroxyl equivalent weight of 382.

### COMPARATIVE EXAMPLE 10B

A 250 mL stainless steel reactor was filled with 100 grams of o-dichlorobenzene, and heated to 200° C. under a pressure of 52 psi. Subsequently, a mixture of 31.65 grams of n-butylacrylate, 29.02 grams of n-butylmethacrylate, 37.85 grams of HEMA and 1.48 grams of di-t-butyl peroxide was fed to the reactor over a period of 6 hours. After cooling, the reaction product was stripped in vacuo to remove the volatiles. The product was characterized by an Mn of 929, a Mw of 1273, and a measured Tg of −50° C. and a hydroxyl equivalent weight of 382.

### EXAMPLE 10C AND EXAMPLE 10D: COATINGS ANALYSIS FOR EXAMPLES 10A AND 10B, RESPECTIVELY

Samples of 10A and 10B were evaluated in clearcoating formulations, the components of which are shown in Table 10-1. Coating panels were prepared by mixing components (i) & (ii), followed by application with a 2.0 mil Bird bar on glass plates. Viscosity increase was measured with a Brookfield viscometer.

TABLE 10-1

| | Example 10C | Example 10D |
|---|---|---|
| Component (i) | | |
| Resin example 10A | 22.22 grams | — |
| Resin example 10B | — | 22.20 grams |
| DBTDL (1% in xylene) | 1.33 grams | 1.33 grams |
| Byk 358 | 0.23 grams | 0.23 grams |
| Byk 306 | 0.06 grams | 0.05 grams |
| nBuAc | 10.45 grams | 12.63 grams |
| Component I(ii) | | |
| HDT 100LV | 11.49 grams | 11.50 grams |
| nBuAc | 3.30 grams | 3.30 grams |

As the data in Table 10-2 indicates, the coating example 10C, comprising resin example 10A, exhibited slower viscosity increase and slower gel time compared with the coating example 10D, made with comparative resin example 10B. Both coatings exhibited similar drying times. A slower viscosity increase without adversely affecting drying characteristics is advantageous for sprayable coating formulations as it extends the usable pot-life of the formulation.

TABLE 10-2

| | Example 10C | Example 10D |
|---|---|---|
| Viscosity | | |
| Initial Viscosity (100 s−1, cPs) | 88 | 84 |
| 30 min viscosity (100 s−1, cPs) | 306 | 311 |
| 60 min viscosity (100 s−1, cPs) | 1383 | 2424 |
| Gel Tim | 90 minutes | 67 minutes |
| Dry Times | | |
| Set to Touch | 74 | 83 |
| Dust Free | 247 | 235 |
| Hard Dry | 286 | 276 |
| Through Dry | 358 | 366 |

### EXAMPLE 11

Example 11 illustrates the preparation of crosslinkable oligomers with a high concentration of hydroxyl functional chain ends, block copolymerization of these crosslinkable oligomers, and the effect of crosslinkable functional group control on clearcoating properties, in accordance with the present invention. Example 11A describes the formation of a high hydroxyl functional oligomer with a hydroxyl functional, unsaturated end group. It is used in example 11B, a copolymerization with a type (II) non-crosslinkable functional monomer, nBMA, to form a copolymer with a hydroxyl functional block, non-functional block and hydroxyl functional, unsaturated end group. Example 11C describes the formation of a low hydroxyl functional oligomer with a hydroxyl functional, unsaturated end group. It is used in example 11D, a copolymerization with a mixture of crosslinkable and non-crosslinkable type (II) monomers, HPMA and nBMA, respectively, to form a copolymer with a random distribution of crosslinkable functionality. Example 11E and 11F describe coating formulations using examples 11B and 11D, respectively.

### EXAMPLE 11A

A high hydroxyl functional oligomer with a hydroxyl functional, unsaturated end group was formed by adding 72.5 grams of EEP (ethyl 3-ethoxypropionate) to a 250 mL stainless steel reactor. The reactor pressure was raised to 45 psi, the temperature was raised to 200° C., and a mixture of 24.9 g HEA, 83.6 g of HPMA, 56.5 g of BMA and 2.5 grams of di-t-butyl peroxide was fed into this reactor over a period of 6 hours to obtain Example 11A.

A sample of 11A was analyzed after removal of the volatiles in vacuo to have an Mn of 940, an Mw of 1260, and an Mz of 1724; the hydroxy equivalent weight of this material was 212. The monomer conversion at this stage was 72%.

### EXAMPLE 11 B

A copolymer with a hydroxyl functional block, non-functional block and hydroxyl functional, unsaturated end group was formed by transferring 200 grams of the above reaction mixture example 11A into a second reactor. The second reactor was heated to 140° C. A mixture of 127.1 grams of BMA and 1.9 gram of AMBN initiator was added of a period of 5 hours. After the reaction mixture was maintained at 140° C. for an additional 35 minutes, it was cooled to room temperature to obtain example 11 B. Example 11B is characterized by an Mn 2110, Mw 3840, Mz 6070, and a hydroxy equivalent weight of 432.

### EXAMPLE 11C

A low hydroxyl functional macromonomer with a hydroxyl functional unsaturated end group was formed by adding 72.5 grams of EEP to a 250 mL stainless steel reactor. The reactor pressure was raised to 45 psi, the temperature was raised to 200° C., and a mixture of 24.9 g HEA, 24.8 g of HPMA, 115.3 g of BMA and 2.5 grams of di-t-butyl peroxide was fed into the reactor over a period of 6 hours to obtain Example 11C.

A sample of 11C was analyzed after removal of the volatiles in vacuo to have an Mn of 870, an Mw of 1150, and an Mz of 1540; the hydroxy equivalent weight of this material is 390. The monomer conversion at this stage wss 66%.

### EXAMPLE 11D

A crosslinkable copolymer with a random distribution of hydroxyl functionality and a hydroxyl functional, unsaturated end group was formed by transferring 200 grams of Example 11C into a second reactor. The second reactor was maintained at 140° C. A mixture of 50.1 grams of HPMA, 70.3 g of BMA and 1.8 gram of AMBN initiator was added over a period of 6 hours. After the reaction mixture at 140° C. was maintained for an additional 30 minutes, it was cooled to room temperature to obtain Example 11D. Example 11D was characterized by an Mn 2090, Mw 3660, Mz 5510, and a hydroxy equivalent weight of 400.

### EXAMPLE 11E AND 1 F. COATING ANALYSIS FOR EXAMPLES 11B AND 11D

Samples of 11 B and 11 D were evaluated in clearcoating formulas, the components of which are shown in Table 11-1. Coating panels were prepared by mixing components (i) and (ii), followed by application either with a 2.0 mil Bird bar on glass plates, or with a 60 RDS applicator baron Bonderite 1000 cold rolled steel plates, as indicated in the Table. Force dry conditions were 2 hours ambient cure at ambient temperature, 12 hours at 120° F. and 4 hours at 140° F.

TABLE 11-1

| | Example 11E | Example 11F |
|---|---|---|
| Component (i) | | |
| Resin example 11B | 28.77 grams | — |
| Resin example 11D | — | 26.28 grams |
| DBTDL (1% in xylene) | 1.46 grams | 1.33 grams |
| Byk 358 | 0.25 grams | 0.23 grams |
| Byk 306 | 0.06 grams | 0.05 grams |
| nBuAc | 14.3 grams | 10.41 grams |
| Component (ii) | | |
| HDT 100LV | 10.45 grams | 9.67 grams |
| nBuAc | 3.00 grams | 2.78 grams |

The resulting coatings data, presented in Table 11-2, illustrate that examples 11E and 11F have similar pot-life, gel time and dry times. Unexpectedly, however, example 11E, containing resin example 11B and characterized by a block type distribution of hydroxyl functionality, exhibits superior hardness and solvent resistance properties compared to example 11F, which contains resin example 11D and is characterized by a more random distribution of hydroxyl functionality.

TABLE 11-2

| | Example 11E | Example 11F |
|---|---|---|
| Viscosity | | |
| Initial Viscosity (100 s−1, cPs) | 76 | 76 |
| 60 min viscosity (100 s−1, cPs) | 389 | 501 |
| 90 min viscosity (100 s−1, cPs) | 1,709 | — |
| Gel Time (hr:min) | 102 minutes | 92 minutes |
| Dry Times (Glass Plate) | | |
| Set to Touch | 17 minutes | 24 minutes |
| Dust Free | 88 minutes | 86 minutes |
| Dry Through | 364 minutes | 354 minutes |
| Hardness (cold rolled steel) | | |
| KPH (sec) @ 2.1 mils DFT | | |
| AIR DRY 1 day | 43 | 34 |
| AIR DRY 7 day | 81 | 58 |
| FORCE DRY | 212 | 101 |
| MEK double rubs@ 2.1 mils DFT | | |
| (cold rolled steel) | | |
| AIR DRY 1 day | 104 | 83 |
| AIR DRY 2 day | 130 | 94 |
| AIR DRY 7 day | 158 | 107 |
| FORCE DRY | 310 | 227 |

This example illustrates the advantage in controlling crosslinkable functionality distribution in a block type copolymer obtained from crosslinkable oligomers containing high concentrations of terminal unsaturation and hydroxyl functional end groups in accordance with the present invention.

### EXAMPLE 12

Example 12 illustrates the process of adding an initiator to the reaction mixture after substantial completion of the polymerization reaction. A 6.5-liter stainless steel reactor was charged with 1140.0 grams of n-butyl propionate, pressurized to 63 psi and heated to 202° C. A mixture of 875.9 grams of 2-hydroxyethyl acrylate, 37.2 grams of 2-hydroxyethyl methacrylate, 608.8 grams of methyl methacrylate, 979.0 grams of n-butyl methacrylate, 161.6 grams of isobornyl methacrylate and 69.4 grams di-t-butyl peroxide was fed into the reactor over a period of 4 hours. After an additional 40 minutes, the reactor was cooled to 158° C., the pressure lowered to 47 psi and a mixture of 15.4 grams di-t-butyl peroxide and 136.6 grams n-butyl propionate was added to the reactor over a period of 55 minutes. After an additional 50 minutes, the mixture was cooled and a sample of resin was removed for analytical analysis. Monomer conversion was 97%. The final resin was characterized by an Mn 973, Mw 1426, Mz 2091 and a color of 12APHA.

What is claimed is:

1. A process for the preparation of crosslinkable oligomers comprising reacting
at least one monomer having the structure
VHC═CHX (I);
at least one monomer having the structure
WHC═CYZ (II)
wherein V, W, X and Z are independently selected from the group consisting of halogen, R, COR, CO₂H, CO₂R, CN, CONH₂, CONHR, CONR₂, O₂CR, and OR;
R is selected from the group consisting of substituted or unsubstituted alkyl, alkenyl, phenyl, cycloalkyl, cycloalkenyl, heterocyclyl, amino, alkylamino, dilkylamino, aralkyl, silyl or aryl; Y is selected from the group consisting of substituted and unsubstituted alkyl, alkenyl, aryl, and aralkyl; and (I) and/or (II) may be cyclic wherein V and X are bonded together and/or W and Z are bonded together to form a ring that comprises at least four atoms;
to form a reaction mixture; wherein the amount of the monomer or monomers of type (II) in the reaction mixture is between about 50 mole % and about 95 mole % based on the total number of moles of type (I) and type (II) monomers being reacted; and wherein more than 60 mole % of the monomer or monomers of type (I) have a side group containing at least one crosslinkable functional moiety and wherein a pressure sufficient to maintain the monomers of type (I) and (II) in a substantially liquid phase and a temperature between about 170° C. and about 260° C. is maintained throughout the reaction.

2. The process of claim 1 wherein R is substituted and the substituent is selected from the group consisting of hydroxy, epoxy, alkoxy, acyl, acyloxy, silyl, silyloxy, silane, carboxylic acid (and salts), 1,3-dicarbonyl, isocyanato, sulfonic acid (and salts), anhydride, alkoxycarbonyl, aryloxycarbonyl, iminoether, imidoether, amidoether, lactone, lactam, amide, acetal, ketal, ketone, oxazolidinone, carbamate (acyclic and cyclic), carbonate (acyclic and cyclic), halo, dialkylamino, oxaziridine, aziridine, oxazolidine, orthoester, urea (acyclic or cyclic), oxetane, cyano and mixtures thereof.

3. The process according to claim 1 further comprising adding at least one free radical initiator to the monomers of type (I) and (II).

4. The process according to claim 3 wherein the amount of the free radical initiator added is between about 0.1 mole % and about 5 mole % based on the total number of moles of monomer being reacted.

5. The process according to claim 4 wherein the amount of the free radical initiator added is between about 0.1 mole % and about 2 mole %.

6. The process according to claim 5 wherein the amount of the free radical initiator added is between about 0.1 mole % and about 1 mole %.

7. The process according to claim 3 wherein the free radical initiator is peroxide or azo-based.

8. The process according to claim 7 wherein the free radical initiator is selected from the group consisting of ether hydroperoxide, acyl hydroperoxide, di-ether peroxide, di-acyl peroxide, peroxydicarbonate, mixed ether acyl peroxide, mixed ether peroxy carbonate, and mixed acyl peroxy carbonates in which substitution on the peroxide is by an alkyl or aryl group or both.

9. The process according to claim 7 wherein the free radical initiator is selected from the group consisting of tert-amyl hydroperoxide, tert-butyl hydroperoxide, cumyl hydroperoxide, 2,4,4-trimethylpentyl-2-hydrooperoxide, di-tert-butyl peroxide, tert-butyl cumyl peroxide, dicumyl peroxide, 2,2′-azobis(isobutyronitrile), 2,2′-azobis(2-methylbutyronitrile), or mixtures thereof.

10. The process according to claim 1 further comprising adding at least one solvent or diluent to the monomers of type (I) and (II).

11. The process according to claim 10 wherein the solvent or diluent is substantially inert to the radical reaction.

12. A process according to claim 10 in which the diluent is an oligomeric polyester with an OH value of at least 100 mg KOH/g, and a number average molecular weight of less than 2000.

13. The process according to claim 11 wherein the solvent is selected from the group consisting of esters, ketones, carbonates, carbamates, aromatic hydrocarbons, aliphatic hydrocarbons, alcohols, glycol ethers, glycol ether esters, and mixtures thereof.

14. The process according to claim 10 wherein the solvent is an ester solvent selected from the group consisting of methyl acetate, ethyl acetate, n-butyl acetate, n-butyl proprionate, isobutyl acetate, n-pentyl propionate, n-propyl acetate, isopropyl acetate, amyl acetate, and isobutyl isobutyrate.

15. The process according to claim 1 wherein more than 80 mole % of the monomer or monomers of type (I) have the side group containing at least one crosslinkable functional moiety.

16. The process according to claim 1 wherein more than 90 mole % of the monomer or monomers of type (I) have the side group containing at least one crosslinkable functional moiety.

17. The process according to claim 1 wherein 100 mole % of the monomer or monomers of type (I) have the side group containing at least one crosslinkable functional moiety.

18. The process according to claim 1 wherein the monomer of type (I) is selected from the group consisting of hydroxyethyl acrylate, hydroxypropylacryate, hydroxypentyl acrylate (all isomers), hydroxyhexyl acrylate (all isomers), hydroxybutyl acrylate (all isomers), isomers of hydroxypropyl acrylate, 4-hydroxystyrene, 1,4-cyclohexanedimethanol monoacrylate, hydroethyl acrylate capped with ε-caprolactone (TONE monomers), adducts of acrylic acid with mono-epoxides, 2-epoxycyclohexane, glycidol; adducts of carbonate acrylates and amines, hydroxyethyl acrylate capped with polyethylene oxide, hydroxypropylacryate capped with polyethylene oxide, hydroxyhexyl acrylate capped with polyethylene oxide, isomers of hydroxybutyl acrylate capped with polyethylene oxide, hydroxyethyl acrylate extended with polypropylene oxide, hydroxypropylacryate extended with polypropylene oxide, hydroxyhexyl acrylate extended with polypropylene oxide, isomers of hydroxybutyl acrylate extendedwith polypropylene oxide, isomers of hydroxybutyl acrylate extendedwith polypropylene oxide and mixtures thereof.

19. The process according to claim 1 wherein the monomer of type (I) is selected from the group consisting of glycidyl acrylate, 4-hydroxybutyl acrylate glycidyl ether, vinylcyclohexene oxide, allyl glycidyl ether, N-glycidyl acrylamide, acrylate monomers with an alicyclic epoxy group, and mixtures thereof.

20. The process according to claim 1 wherein the monomer of type (I) is selected from the group consisting of vinyloxytrimethylsilane, trimethoxysilylpropyl acrylate, triethoxysilylpropyl acrylate, dimethoxysilylpropyl acrylate, diethoxysilylpropyl acrylate, dibutoxysilylpropyl acrylate, diisopropxysilylpropyl acrylate, and mixtures thereof.

21. The process according to claim 1 wherein the monomer of type (I) is selected from the group consisting of acrylic acid, β-carboxyethyl acrylate, 3-vinylbenzoic acid, 4-vinyl benzoic acid, vinyl acetate, vinyl benzoate, vinyl 4-tert-butyl benzoate, vinyl esters of versatic acid, acryloyloxyethylsuccinate, maleic acid, fumaric acid, and half-acid/esters of maleic anhydride, diacetone acrylamide, acryloyoloxy ethyl acetoacetate, 2-vinyl-1,3-dioxolane, vinyl ethylene carbonate, N-vinylcaprolactam, acrylamide, N-hydroxymethylacryamide, 2-N-ethyleneurea-ethyloxyacrylate, and 2-N-ethyleneurea -ethyl-acrylamide and mixtures thereof.

22. The process according to claim 1 wherein the monomer of type (I) is selected from the group consisting of dimethylaminoethyl acrylate, diethylaminoethyl acrylate, dimethylaminoethyl acrylamide, n-t-butylaminoethyl acrylate, monomers resulting from the reaction of t-butyl amine or dialkyl amines with glycidyl acrylate, and mixtures thereof.

23. The process according to claim 1 wherein the monomer of type (I) is selected from the group consisting of acrylic acid anhydride, alkenyl succinic anhydride, maleic anhydride, vinyl hexahydropthalic anhydride isomers, 3-methyl-1,2,6-tetrahydrophthalic anhydride, 2-methyl-1,3,6-tetrahydrophthalic anhydride, 2-(¾ vinyl benzyl) succinic acid, (2-succinic anhydride) acrylate, bicyclo [2.2.1] hept-5-ene-2-spiro-3′-exo-succinic anhydride, alkenyl succinic anhydrides, and mixtures thereof.

24. The process according to claim 1 wherein the monomer of type (I) is selected from the group consisting of methylated N-methylol acrylamide, butylated N-methylol acrylamide, vinyl N-alkoxymethyl derivative of succinimide, phthalimide, N-alkoxymethyl 1,2,3,6-tetrahydrophthalimide anhydride, N-alkoxymethylmaleimide, and mixtures thereof.

25. The process according to claim 1 wherein the monomer of type (I) is selected from the group consisting of methyl acrylate, ethyl acrylate, propyl acrylate, isomers of propyl acrylate, butyl acrylate, isomers of butyl acrylate, hexyl acrylate, 2-ethylbutyl acrylate, 2-ethylhexyl acrylate, isobornyl acrylate, isoamyl acrylate, benzyl acrylate, phenyl acrylate, cyclohexyl acrylate, lauryl acrylate, isodecyl acrylate, styrene, cetyl acrylate, and mixtures thereof.

26. The process according to claim 1 wherein the monomer of type (II) is selected from the group consisting of methyl methacrylate, ethyl methacrylate, propyl methacrylate, isomers of propyl methacrylate, butyl methacrylate, isomers of butyl methacrylate, hexyl methacrylate, 2-ethylbutyl methacrylate, crotyl methacrylate, 2-ethylhexyl methacrylate, isobornyl methacrylate, isoamyl methacrylate, benzyl methacrylate, phenyl methacrylate, tetrahydrofurfuryl methacrylate, 3,3,5-trimethylcyclohexyl methacrylate, alphamethylstyrene, cyclohexyl methacrylate, stearyl methacrylate, lauryl methacrylate, isodecyl methacrylate, and mixtures thereof.

27. The process according to claim 1 wherein the monomer of type (II) selected from the group consisting glycidyl methacrylate, 2-hydroxyethyl methacrylate, hydroxypropyl methacrylate, isomers of hydroxypropyl methacrylate, hydroxybutyl methacrylate, isomers of hydroxybutyl methacrylate, glycerolmonomethacrylate, methacrylic acid, itaconic anhydride, citraconic anhydride, dimethylaminoethyl methacrylate, diethylaminoethyl methacrylate, dimethylaminopropyl methacrylamide, 2-tert-butyl aminoethyl methacrylate, triethyleneglycol methacrylate, methacrylamide, N,N-dimethyl methacrylamide, N-tert-butyl methacrylamide, N-methylol methacrylamide, N-ethylol methacrylamide, alphamethylvinyl benzoic acid (all isomers), diethylamino alphamethylstyrene, 2-isocyanatoethyl methacrylate, isomers of diethylamino alphamethylstyrene, trimethoxysilylpropyl methacrylate, triethoxysilylpropyl methacrylate, methacrylic acid, tributoxysilylpropyl methacrylate, dimethoxymethylsilylpropyl methacrylate, d diisopropoxymethylsilylpropyl methacrylate, dimethoxysilylpropyl methacrylate, diethoxysilylpropyl methacrylate, dibutoxysilylpropyl methacrylate, diisopropoxysilylpropyl methacrylate, isobutylene, and mixtures thereof.

28. The process according to claim 1 wherein the amount of the monomer or monomers of type (II) is between about 55 mole % and about 90 mole %.

29. The process according to claim 28 wherein the amount of the monomer or monomers of type (II) is between about 60 mole % and about 80 mole %.

30. The process according to claim 1 wherein the temperature is maintained between about 175° C. and about 240° C.

31. The process according to claim 30 wherein the temperature is maintained between about 185° C. to about 220° C.

32. The process according to claim 31 wherein the temperature maintained between about 190° C. and about 210° C.

33. The process according to claim 1 further comprising adding at least one free radical initiator at the completion of the reaction at a temperature below about 170° C.

34. The process according to claim 33 wherein the free radical initiator is peroxide or azo-based.

35. A process according to claim 1 further comprising at least one copolymerization step wherein the crosslinkable oligomer is further reacted with at least one second free radical initiator and at least one additional monomer or monomers, the additional monomer or monomers being selected from the group consisting of the monomers of type (I), the monomers of type (II), and monomers having the following structure:
(CH₂═CH)ₙ—U—(CY′═CHW′)ₘ (III)
where n is greater than or equal to 0; m is greater than or equal to 0; n+m is greater than or equal to 2; Y′ and W′ are defined as for Y and W, respectively, in the type (II) monomers; and U is a point of attachment for more than one C═C units.

36. The process of claim 35 wherein the type (III) monomer is selected from the group consisting of divinylbenzene, trimethylolpropane trimethacrylate, trimethylolpropane triacrylate, glycerol-1,3-dimethacrylate, polyethylene glycol 200-dimethacrylate, allyl methacrylate, 1,4-butanediol dimethacrylate, 1,4-butanediol diacrylate 1,3-butanediol dimethacrylate, ethyleneglycol dimethacrylate, ethyleneglycol diacrylate, triethylene glycol dimethacrylate, triethylene glycol diacrylate 1,6-hexanediol dimethacrylate, diurethane dimethacrylate, 2,2-bis[4-(2-hydroxy-3-methacryloyloxy -propoxy)phenyl]-propane, 1,12-dodecanediol dimethacrylate, and mixtures thereof.

37. A process according to claim 35 wherein more than 50 mole % of the additional monomer or monomers are type (II) monomers;
the average OH value of the additional monomer or monomers is less than half of the average OH value of the crosslinkable oligomer; and
the mass of the additional monomer or monomers is greater than half of the mass of the crosslinkable oligomer.

38. A process according to claim 35 wherein
more than 50 mole % of the additional monomer or monomers are type (II) monomers;
the average OH value of the additional monomer or monomers is more than twice the average OH value of the crosslinkable oligomer; and
the mass of the additional monomer or monomers is less than half of the mass of the crosslinkable oligomer.

39. A process according to claim 33 further comprising at least one copolymerization step wherein the crosslinkable oligomer is further reacted with at least one second free radical initiator and at least one additional monomer or monomers, the additional monomer or monomers being selected from the group consisting of the monomers of type (I), the monomers of type (II), and monomers having the following structure:
(CH₂═CH)ₙ—U—(CY′═CHW′)ₘ (III)
where n is greater than or equal to 0; m is greater than or equal to 0; n+m is greater than or equal to 2; Y′ and W′ is defined as for Y and W, respectively, in the type (II) monomers; and U is a point of attachment for more than one C═C units.

40. A process according to claim 39 wherein
more than 50 mole % of the additional monomer or monomers are type (II) monomers;
the average OH value of the additional monomer or monomers is less than half of the average OH value of the crosslinkable oligomer; and
the mass of the additional monomer or monomers is greater than half of the mass of the crosslinkable oligomer.

41. A process according to claim 39 wherein
more than 50 mole % of the additional monomer or monomers are type (II) monomers;
the average OH value of the additional monomer or monomers is more than twice the average OH value of the crosslinkable oligomer; and
the mass of the additional monomer or monomers is less than half of the mass of the crosslinkable oligomer.

42. The process according to claim 1 further comprising at least one additional step wherein the crosslinkable oligomer is further reacted with one or more reagents having at least one functional group wherein said functional group is capable of modifying one or more of the crosslinkable functional moieties of the type (I) monomer or monomers to obtain a new crosslinkable oligomer.

43. The process according to claim 42 wherein the functional group is seletected from the group consisting of epoxy, silyl, isocyanato, amino, anhydride, hydroxy, iminoether, imidoether, amidoether, carbamate, cyano, lactone, lactam, carbamate (acyclic and cyclic), carbonate (acyclic and cyclic), aziridine, anhydride, amine, carboxylic acid, and mixtures thereof.

44. Crosslinkable oligomers obtained by the process according to claim 1.

45. The oligomers of claim 44 wherein the oligomer has a number average degree of polymerization between about 3 and about 24.

46. The oligomers of claim 45 wherein the number average degree of polymerization is between about 3 and about 15.

47. The oligomers of claim 46 wherein the number average degree of polymerization is between about 3 and about 10.

48. A block, branched, star or comb-like graft crosslinkable copolymer comprising the crosslinkable oligomers of claim 44.

49. A coating comprising the oligomers of claim 44.

50. A lubricant comprising the oligomers of claim 44.

51. A sealant comprising the oligomers of claim 44.

52. An adhesive comprising the oligomer of claim 44.

53. Crosslinkable oligomers obtained by the process according to claim 17.

54. A block, branched, star or comb-like graft crosslinkable copolymer comprising the crosslinkable oligomers of claim 53.

55. A coating comprising the oligomers of claim 53.

56. A lubricant comprising the oligomers of claim 53.

57. A sealant comprising the oligomers of claim 53.

58. An adhesive comprising the oligomer of claim 53.
